(19) United States
(12) Patent Application Publication
(10) Pub. No.: US 2023/0179144 A1
(43) Pub. Date: Jun. 8, 2023

(54) METHOD AND APPARATUS FOR RECOGNIZING OPERATING STATE OF PHOTOVOLTAIC STRING AND STORAGE MEDIUM

(71) Applicants: ENVISION DIGITAL INTERNATIONAL PTE. LTD., Singapore (SG); SHANGHAI ENVISION DIGITAL CO., LTD., Shanghai (CN)

(72) Inventors: Jing CHANG, Pilot Free Trade Zone, Shanghai (CN); Jie SUN, Pilot Free Trade Zone, Shanghai (CN); Jinlin YANG, Pilot Free Trade Zone, Shanghai (CN); Zhousheng LI, Pilot Free Trade Zone, Shanghai (CN); Kang JIAN, Pilot Free Trade Zone, Shanghai (CN); Huirong JIANG, Pilot Free Trade Zone, Shanghai (CN)

(21) Appl. No.: 17/791,336

(22) PCT Filed: Jan. 8, 2021
(86) PCT No.: PCT/SG2021/050017

§ 371 Date: Jul. 7, 2022

(30) Foreign Application Priority Data
Jan. 9, 2020 (CN) 202010022031.2

(51) Int. Cl. H02S 50/10; H02S 40/36

(52) U.S. Cl. CPC H02S 50/10; H02S 40/36

(57) ABSTRACT

A method and apparatus for recognizing an operating state of a photovoltaic string. The method includes: calculating a theoretical power and a theoretical maximum short-circuit current of a photovoltaic string under a current operating condition; calculating a typical year theoretical power and a typical year maximum short-circuit current of the photovoltaic string; and establishing standard state parameters of the photovoltaic string based on the theoretical power, the theoretical maximum short-circuit current, the typical year theoretical power, and the typical year maximum short-circuit current of the photovoltaic string. The method further including acquiring operating state parameters of the photovoltaic string under the current operating condition; and determining the operating state of the photovoltaic string by comparing the operating state parameters of the photovoltaic string with the corresponding standard state parameters of the photovoltaic string.

### TECHNICAL FIELD

The present disclosure relates to the field of photovoltaic technologies, and more particularly to a method and apparatus for recognizing an operating state of a photovoltaic string, and a storage medium.

### BACKGROUND

In actual running of a photovoltaic field station, failures often occur in a photovoltaic string regarding power generation performance, such as low or abnormal power generation performance. Therefore, inspection and maintenance are needed in order to reduce a loss of power generation of the photovoltaic field station.

In the related art, operation and maintenance personnel are assigned to inspect photovoltaic modules in the photovoltaic field station. Specifically, by comparing or ranking respective photovoltaic strings in the photovoltaic field station, photovoltaic strings with power generation performance with a low ranking or of a severe deviation from an average level is defined as problematic photovoltaic strings.

However, misjudgment easily occurs during comparing or ranking the photovoltaic strings because different photovoltaic strings have different power generation performance due to variations in the installation process. As a result, accuracy of determination of the operating state of a photovoltaic string is low.

### SUMMARY

Embodiments of the present disclosure provide a method and apparatus for recognizing an operating state of a photovoltaic string, and a storage medium, which may improve accuracy in determining an operating state of a photovoltaic string.

In one aspect, a method for recognizing an operating state of a photovoltaic string is provided.

The method includes: calculating a theoretical power and a theoretical maximum short-circuit current of the photovoltaic string under a current operating condition, wherein the photovoltaic string is a circuit unit with a DC output formed by at least two photovoltaic modules connected in series; calculating a typical year theoretical power and a typical year maximum short-circuit current of the photovoltaic string; establishing standard state parameters of the photovoltaic string based on the theoretical power, the theoretical maximum short-circuit current, the typical year theoretical power, and the typical year maximum short-circuit current of the photovoltaic string, wherein the standard state parameters include a power threshold and a short-circuit current threshold of the photovoltaic string; acquiring operating state parameters of the photovoltaic string under the current operating condition, the operating state parameters including an operating power and an operating current of the photovoltaic string; and determining the operating state of the photovoltaic string by comparing the operating state parameters of the photovoltaic string with the corresponding standard state parameters of the photovoltaic string.

In another aspect, an apparatus for recognizing an operating state of a photovoltaic string is provided.

The apparatus includes: a first calculating module, configured to calculate a theoretical power and a theoretical maximum short-circuit current of the photovoltaic string under a current operating condition, wherein the photovoltaic string is a circuit unit with a DC output formed by at least two photovoltaic modules connected in series; a second calculating module, configured to calculate a typical year theoretical power and a typical year maximum short-circuit current of the photovoltaic string; a standard establishing module, configured to establish standard state parameters of the photovoltaic string based on the theoretical power, the theoretical maximum short-circuit current, the typical year theoretical power, and the typical year maximum short-circuit current of the photovoltaic string, wherein the standard state parameters include a power threshold and a short-circuit current threshold of the photovoltaic string; a first acquiring module, configured to acquire operating state parameters of the photovoltaic string under the current operating condition, wherein the operating state parameters include an operating power and an operating current of the photovoltaic string; and a determining module, configured to determine the operating state of the photovoltaic string by comparing the operating state parameters of the photovoltaic string with the corresponding standard state parameters of the photovoltaic string.

In some embodiments, the standard establishing module further includes: a first acquiring sub-module, configured to determine a smaller one of the theoretical power and the typical year theoretical power of the photovoltaic string as the power threshold; and a second acquiring sub-module, configured to determine a smaller one of the theoretical maximum short-circuit current and the typical year maximum short-circuit current of the photovoltaic string as the short-circuit current threshold.

In some embodiments, the apparatus further includes: a second acquiring module, configured to acquire, at a preset interval, an instantaneous irradiancy of a photovoltaic field station where the photovoltaic string is installed, a third acquiring module, configured to determine a period during which the instantaneous irradiancy of the photovoltaic field station is greater than or equal to an irradiancy threshold as a detection period; and a fourth acquiring module, configured to determine an operating condition in a specified period within the detection period as the current operating condition.

In some embodiments, the first acquiring module is configured to acquire a DC side operating current and an operating power of a DC combiner box or a string-type inverter of the photovoltaic string under the current operating condition in the detection period.

In some embodiments, the first calculating module includes: a third acquiring submodule, configured to acquire an irradiancy, an ambient temperature, and a wind speed of a photovoltaic field station under the current operating condition based on meteorological data corresponding to the photovoltaic field station in response to presence of the meteorological data, a first calculating submodule, configured to calculate temperatures of photovoltaic modules in the photovoltaic string under the current operating condition based on the irradiancy, the ambient temperature, and the wind speed of the photovoltaic field station under the current operating condition; a second calculating submodule, configured to calculate temperatures of cells of the photovoltaic modules under the current operating condition based on the temperatures of the photovoltaic modules; a third calculating submodule, configured to calculate an average operating temperature of the cells of the photovoltaic modules corresponding to the current operating condition based on irradiancies of the photovoltaic modules at a detection time corresponding to the current operating condition in a typical year and the temperatures of the photovoltaic modules at the detection time corresponding to the current operating condition in a typical year, and a fourth calculating submodule, configured to calculate the theoretical power and the theoretical maximum short-circuit current of the photovoltaic string under the current operating condition based on the irradiancy of the photovoltaic field station under the current operating condition, the average operating temperature of the cells of the photovoltaic modules and the temperatures of the cells of the photovoltaic modules under the current operating condition.

In some embodiments, the first calculating module includes: a fourth acquiring submodule, configured to acquire a maximum current in all photovoltaic strings under the current operating condition in response to a case where the meteorological data corresponding to the photovoltaic field station is not present; a fifth calculating submodule, configured to calculate the irradiancy of the photovoltaic field station under the current operating condition based on the maximum current; and a sixth calculating submodule, configured to calculate the theoretical power and the theoretical maximum short-circuit current of the photovoltaic string in the photovoltaic field station based on the irradiancy of the photovoltaic field station under the current operating condition, the short-circuit current of the photovoltaic modules under a standard operating condition and the irradiancies of the photovoltaic modules under a standard test condition.

In some embodiments, the second calculating module includes: a fifth acquiring submodule, configured to acquire irradiancies of the photovoltaic field station in a typical year based on a geographic location of the photovoltaic field station, wherein an interval of collecting an irradiancy of the photovoltaic field station in the typical year is identical to an interval of acquiring an irradiancy of the photovoltaic field station under an operating condition; a selecting submodule, configured to select the maximum irradiancy among the irradiancies of the photovoltaic field station in the typical year at a detection time corresponding to the current operating condition; and a seventh calculating submodule, configured to calculate the typical year theoretical power, and the typical year maximum short-circuit current of the photovoltaic string in the photovoltaic field station based on the maximum irradiancy.

In some embodiments, the determining module includes: a first determining submodule, configured to determine that a power of the photovoltaic string is inflated in response to a case where the operating state parameters of the photovoltaic string are greater than the standard state parameters of the photovoltaic string for a duration longer than a first time-threshold; a second determining submodule, configured to determine that a short-circuit occurs in the photovoltaic string in response to a case where a current in the operating state parameters of the photovoltaic string is less than a current threshold for a duration greater than a second time-threshold; and a third determining submodule, configured to determine that the current or the power of the photovoltaic string is low in response to a case where the operating state parameters of the photovoltaic string are less than weighted standard state parameters of the photovoltaic string for a duration greater than a third time-threshold.

In yet another aspect, a computer device is provided. The computer device includes a processor and a memory storing at least one instruction, at least one program, a code set, or an instruction set; wherein the at least one instruction, the at least one program, the code set, or the instruction set, when loaded and executed by the processor, causes the processor to perform the method for recognizing the operating state of the photovoltaic string of the above-mentioned aspect.

In yet another aspect, a non-transitory computer-readable storage medium is provided. The storage medium stores at least one instruction, at least one program, a code set or an instruction set, wherein the at least one instruction, the at least one program, the code set, or the instruction set, when loaded and executed by a processor of a computer device, causes the computer device to perform the method for recognizing the operating state of the photovoltaic string of the above-mentioned aspect.

The technical solutions according to the present disclosure may achieve the following beneficial effects.

In the present disclosure, a theoretical power and a theoretical maximum short-circuit current of a photovoltaic string under a current operating condition as well as a typical year theoretical power and a typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving accuracy in determining the operating state of a photovoltaic string.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 illustrates a flowchart of a method for recognizing an operating state of a photovoltaic string according to an exemplary embodiment of the present disclosure;

FIG. 2 illustrates a flowchart of a method for recognizing an operating state of a photovoltaic string according to an exemplary embodiment of the present disclosure;

FIG. 3 illustrates a flowchart of a method for recognizing an operating state of a photovoltaic string according to an exemplary embodiment of the present disclosure;

FIG. 4 illustrates a flowchart of a method for recognizing an operating state of a photovoltaic string according to an exemplary embodiment of the present disclosure;

FIG. 5 illustrates a flowchart of a method for recognizing an operating state of a photovoltaic string according to an exemplary embodiment of the present disclosure;

FIG. 6 illustrates a block diagram of a device for recognizing an operating state of a photovoltaic string according to an exemplary embodiment of the present disclosure; and

FIG. 7 illustrates a structural block diagram of a computer device according to an exemplary embodiment of the present disclosure.

### DETAILED DESCRIPTION

Descriptions are made in detail with respect to some embodiments, examples of which are illustrated in the accompanying drawings. The following description refers to the accompanying drawings in which the same reference numerals in different drawings represent the same or similar elements, unless otherwise specified. The embodiments set forth in the following description of exemplary embodiments do not represent all implementations consistent with the present disclosure. Instead, these embodiments are merely examples of apparatuses and methods consistent with aspects related to the disclosure as recited in the appended claims.

Understandably, the term “a plurality of” herein refers to two or more, and the term. The term “and/or” herein describes association relationships of the associated objects, indicating three relationships. For example, A and/or B, can be expressed as: A exists alone, A and B exist concurrently, B exists alone. The symbol “/” generally indicates an “OR” relationship between the contextual objects.

In operation and maintenance of a photovoltaic field station, a troubleshoot on an operating state of photovoltaic strings is necessary. The present disclosure provides a method for recognizing an operating state of a photovoltaic string, and the method may improve accuracy in determining an operating state of a photovoltaic string. For easy understanding, terms involved in embodiments of the present disclosure are explained below.

1) Photovoltaic String

A photovoltaic string, referred to as a string of modules, is a circuit unit with a DC output formed by several photovoltaic modules connected in series in a photovoltaic system.

2) Photovoltaic Module

The photovoltaic module, also known as a solar panel, is formed by connecting in series, connecting in parallel, and then tightly packaging several unit cells. The photovoltaic module may convert solar energy into electric energy and send the electric energy to a battery for storage or drive a load thereby. Conventional photovoltaic modules are classified into double-glass modules, conventional modules, thin-film modules, and the like.

3) Typical Meteorological Year (TMY)

The typical meteorological year is simply referred to as a typical year in the embodiments of the present disclosure. The typical year is a data year composed of a series of hourly meteorological data such as solar radiation. The Typical year has the following characteristics:

(1) A distribution of occurrence frequency of meteorological data such as solar radiations, air temperatures and wind speeds in the typical year is similar to a long-term distribution of occurrence frequency of meteorological data in the past years;

(2) Meteorological parameters of the typical year have similar continuity of daily parameter standards to meteorological parameters of the past years;

(3) Meteorological parameters of the typical year and parameters in the past years have correlations between different parameters.

The typical year may be a typical meteorological year composed of 12 typical monthly meteorological data calculated and selected from the past years of meteorological data, or may be determined by performing selection and calculation on typical meteorological years of different cities and regions with different weighting factors.

4) Irradiancy

An irradiancy is defined as energy per unit area.

5) Current Operating Condition

In the embodiments of the present disclosure, the current operating condition means a condition such as climate and irradiancy corresponding to a period during which an operating state recognition is performed by employing the present method during actual operation of the photovoltaic string for which an operating state recognition is needed.

6) Theoretical Power and Operating Power

The theoretical power means a power that should be output by a photovoltaic string under a current operating condition in theoretical calculation, and the operating power means a power actually output by a photovoltaic string under a current operating condition in actual operation.

In general, a difference is recognized between the operating power and the theoretical power, and the difference is due to a natural environment, a line loss, and the like. Generally, the operating power is less than the theoretical power in normal operation of the photovoltaic string.

7) Theoretical Short-Circuit Current and Operating Current

A short-circuit current means a current that flows when an abnormal connection (i.e., short-circuit) occurs between phases or between phase and ground (or neutral) during running of a power system.

The theoretical short-circuit current may indicate a maximum current that may be generated in a photovoltaic string under a current operating condition, and the operating current means a current generated in the photovoltaic string during actual operation under a current operating condition.

In normal operation of a photovoltaic string, the operating current is less than the theoretical short-circuit current.

8) Typical Year Theoretical Power and Typical Year Maximum Short-Circuit Current

With reference to the above-mentioned explanations of the typical year, there are usually multiple typical years. Among these typical years, the climate data of the typical year with the highest irradiancy is selected for calculating the typical year theoretical power and typical year maximum short-circuit current of the typical year.

That is, the typical year theoretical power means maximum power that may be output by the photovoltaic string under an operating condition of the typical year, and the typical year maximum short-circuit current means a maximum current that may be generated in the photovoltaic string under the operating condition of the typical year.

In actual running a photovoltaic field station, failures often occurs in a photovoltaic string regarding power generation performance, such as low or abnormal power generation performance. However, an operation and maintenance personnel may not accurately judge or analyze reasons for low power generation performance based on currents and voltages of photovoltaic strings. Further, since a large amount of data is stored on the platform, it is hard to effectively guide operation and maintenance by using these data, which result in a loss of power generation of the photovoltaic field station. Besides, the number of photovoltaic strings in a photovoltaic field station is very large, for example, a 1 MW photovoltaic power plant generally includes 165-185 photovoltaic strings. In a large photovoltaic field station, particularly a ground power plant or a distributed-type photovoltaic power plant with multiple roofs, situations of the installation field of photovoltaic modules are often complex and different from one another. For example, installation azimuths, installation inclinations, and shading states of respective photovoltaic modules are different, and therefore it is difficult to accurately determine those photovoltaic strings with real low power generation performance and reasons of failures from the aspect of data.

In a conventional method, the photovoltaic strings are compared with each other or are ranked to define a photovoltaic string of which power generation performance of low rank or of severe deviation from an average level as problematic, such that the photovoltaic string with low power generation performance may be directly recognized. However, since it is normal that different photovoltaic strings have different power generation performance due to variations in installation information as previously discussed, actually damaged photovoltaic strings with power generation performance of middle rank are not correctly recognized and may be easily neglected although they are photovoltaic strings with real low power generation performance. Besides, sometimes since data may not be accurately transmitted to a monitoring platform or data abnormalities occur due to communication failures in the photovoltaic field, and a misjudgment may occur on a photovoltaic string of lowest rank when data abnormalities are too large, while performance of this photovoltaic string does not really become low. Therefore, bigdata acquired by a photovoltaic cloud monitor platform should be used to perform an algorithm analysis to restore real generation performance of photovoltaic strings, such that a real situation of the power generation performance of photovoltaic strings in the photovoltaic field station may be accurately determined and failure reasons may be analyzed and classified, by which advice may be concluded for improving operating efficiency of an operation and maintenance personnel to overcome failures, thereby reducing a loss of power generation of the photovoltaic power plant.

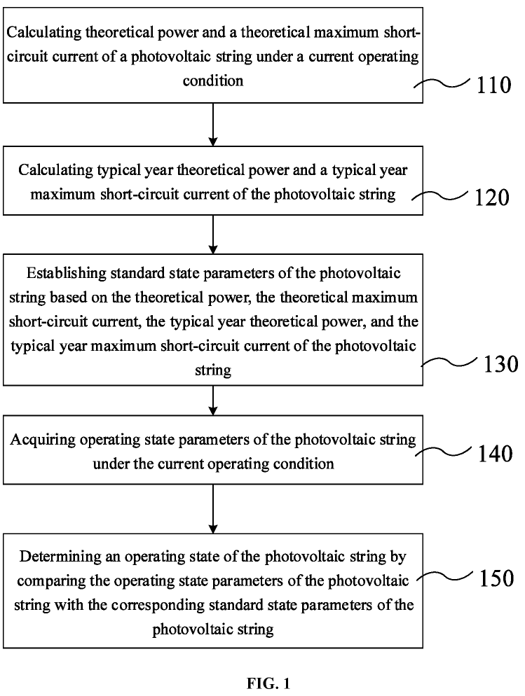

FIG. 1 illustrates a flowchart of a method for recognizing an operating state of a photovoltaic string according to an exemplary embodiment of the present disclosure. The method may be performed by a server. As shown in FIG. 1, the method may include the following steps:

In step 110, a theoretical power and a theoretical maximum short-circuit current of a photovoltaic string under the current operating condition are calculated. The photovoltaic string is a circuit unit with a DC output formed by at least two photovoltaic modules connected in series.

A solar cell may only generate a voltage of 0.5 V, which is far lower than the voltage required for practical use. In order to meet requirements of practical applications, solar cells need to be connected into a solar cell module. A solar cell module contains a number of solar cells connected in series or in parallel, such that a solar module may generate more electric power to meet requirements of practical applications.

In a photovoltaic generation system, several photovoltaic modules are generally connected in series to form a circuit unit having a DC output for ensuring capacity to meet increased capacity requirements on photovoltaic modules. Since the number of photovoltaic modules contained in one photovoltaic string is not limited, it is necessary to perform design and adjustment according to an actual installation field and an environment of the photovoltaic string.

In step 120, a typical year theoretical power and a typical year maximum short-circuit current of the photovoltaic string are calculated.

Referring to the above-mentioned explanation of the typical year, the typical year theoretical power, and the typical year maximum short-circuit current are calculated based on data with the largest irradiancy in the typical year. For example, a typical year may be selected based on meteorological data of the past twenty years for summarizing the change characteristics of the meteorological data of the past twenty years. The maximum irradiancy in the typical year is selected for calculating the typical year theoretical power and the typical year maximum short-circuit current of the photovoltaic string.

In step 130, standard state parameters of the photovoltaic string are established based on the theoretical power, the theoretical maximum short-circuit current, the typical year theoretical power, and the typical year maximum short-circuit current of the photovoltaic string. The standard state parameters include a power threshold and a short-circuit current threshold of the photovoltaic string.

In step 140, operating state parameters of the photovoltaic string under the current operating condition are acquired. The operating state parameters include an operating power and an operating current of the photovoltaic string.

In step 150, the operating state of the photovoltaic string is determined by comparing the operating state parameters of the photovoltaic string with the corresponding standard state parameters of the photovoltaic string.

In summary, in the method for recognizing an operating state of a photovoltaic string according to the embodiments of the present disclosure, the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy in determining the operating state of a photovoltaic string.

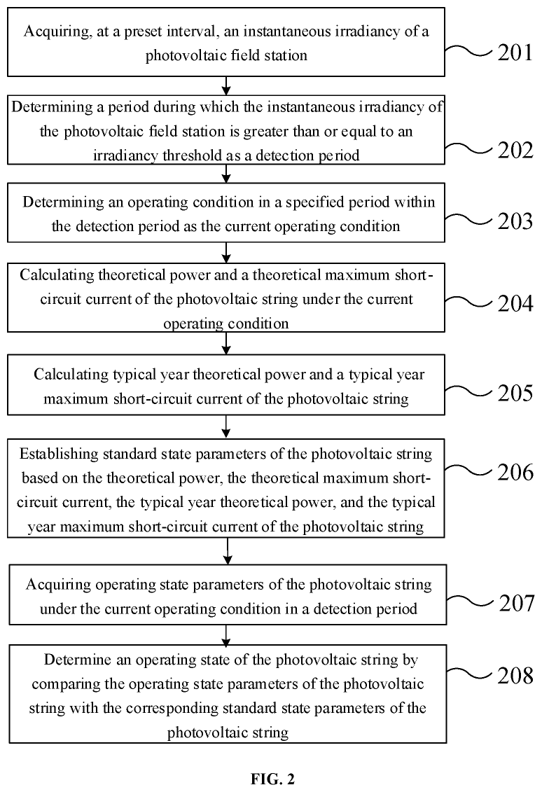

In a case where the photovoltaic field station has a weather station or meteorological data corresponding to the photovoltaic field station may be acquired, FIG. 2 illustrates a flowchart of a method for recognizing an operating state of a photovoltaic string according to an exemplary embodiment of the present disclosure. The method may be performed by a server. As shown in FIG. 2, the method may include the following steps:

In step 201, an instantaneous irradiancy of the photovoltaic field station where the photovoltaic string is installed is acquired at a preset interval.

The irradiancy of a photovoltaic field station includes horizontal irradiancy and oblique irradiancy, which are generally determined based on the angle of the weather station irradiator installed in the photovoltaic field station. When a weather station irradiator is installed horizontally, a detected irradiancy is horizontal irradiancy; and when the weather station irradiator is installed obliquely, a detected irradiancy is oblique irradiancy, wherein an inclination of the irradiator is generally collected by a monitoring platform to which power plant data access. Because photovoltaic modules are usually installed to form an inclination with respect to the ground, it is usually preferred to perform the above calculation with the oblique irradiancy. If the oblique irradiancy is unavailable, the calculation may be performed with the horizontal irradiancy.

In step 202, a period during which the instantaneous irradiancy of the photovoltaic field station is greater than or equal to an irradiancy threshold is determined as a detection period.

The operation of the photovoltaic string depends on the irradiancy, and the power generation changes with the irradiancy. In detail, when the irradiancy rises, the power generation of the photovoltaic string rises accordingly; and when the irradiancy falls, the power generation of the photovoltaic string falls accordingly. Therefore, in order to eliminate interference on recognition to the operating state of the photovoltaic string caused by a decrease of power generation of the photovoltaic string due to a too low irradiancy, the instantaneous irradiancy of the photovoltaic field station is acquired at a preset interval. A period during which the instantaneous irradiancy of the photovoltaic field station is greater than or equal to an irradiancy threshold is determined as a detection period. Due to different geographical locations of different photovoltaic field stations, detection periods of different photovoltaic field stations are also different.

Optionally, the irradiancy threshold is 300 w/m², that is, only data in a period during which the irradiancy is greater than or equal to 300 w/m² is calculated during recognition on the photovoltaic string operating state.

When Hᵢ represents the instantaneous irradiancy of the photovoltaic field station, Hₜₕᵣₑₛ represents the irradiancy threshold, the instantaneous irradiancy Hᵢ of the photovoltaic field station in the detection period satisfies the following relations:

Hᵢ≥Hₜₕᵣₑₛ

In step 203, an operating condition in a specified period within the detection period is determined as the current operating condition.

The current operating condition means characteristic values of the meteorological data corresponding to a period in the detection period. The characteristic value may be instantaneous meteorological data when the data is collected, or be an average of meteorological data during the period.

A period in which the current operating condition is located is determined by a frequency of data collection. For example, the frequency of data collection may be once for every 1 minute, every 5 minutes, or every 10 minutes, accordingly, the corresponding current operating condition is the instantaneous meteorological data of every 1 minute, every 5 minutes, or every 10 minutes. Optionally, the corresponding current operating condition may also be an average of the meteorological data of every 1 minute, every 5 minutes, or every 10 minutes. The frequency of data collection may be set by a tester according to the calculating capacity of the server.

In embodiments of the present disclosure, a case in which the instantaneous meteorological data in data collection is the characteristic value of the meteorological data is took as an example to describe the present disclosure.

In step 204, a theoretical power and a theoretical maximum short-circuit current of a photovoltaic string under the current operating condition are calculated. The photovoltaic string is a circuit unit with a DC output formed by at least two photovoltaic modules connected in series.

In some embodiments, an irradiancy, an ambient temperature, and a wind speed of the photovoltaic field station under the current operating condition are acquired based on meteorological data corresponding to the photovoltaic field station in response to presence of the meteorological data.

Then the temperature of the photovoltaic modules in the photovoltaic string under the current operating condition is calculated based on the irradiancy and the wind speed of the photovoltaic field station under the current operating condition, a formula for calculating the temperature is as follows:

Tₘ=Hᵢ*[e^{(a+b+W}^{ₛ}⁾]+T_{amb}

Tₘ represents a temperature of the photovoltaic module under the current operating condition, Hᵢ is an instantaneous irradiancy of the photovoltaic string corresponding to the current operating condition, Wₛ represents a wind speed, T_{amb} represents an ambient temperature of the photovoltaic field station under the current operating condition, and a, b are constants dependent on a type and installation manner of the photovoltaic module. For details, reference may be made to Table 1.

TABLE 1

| Component type | Installation manner | a | b | Δ T |
|---|---|---|---|---|
| Double-glass module | Fixed inclination | −3.47 | −0.0594 | 3 |
| Double-glass module | Fixed inclination | −2.98 | −0.0471 | 1 |
| conventional module | Fixed inclination | −3.56 | −0.075 | 3 |
| conventional module | Color steel tile | −2.81 | −0.0455 | 0 |
| Thin film module | Fixed inclination | −3.58 | −0.113 | 3 |

Temperatures of cells of the photovoltaic modules under the current operating condition are calculated based on temperatures of the photovoltaic modules. The calculation is based on the following formula:

$${T}_{cell} = {T}_{m} + \frac{{H}_{i}}{{G}_{s t c}} * Δ T$$

T_{cell} represents a temperature of a cell of the photovoltaic module under the current operating condition, G_{stc} represents an irradiancy of the photovoltaic module under a standard test condition and has a value of 1000 W/m², and ΔT represents a temperature parameter dependent on a type and installation manner of the photovoltaic module. For details, reference may be made to Table 1.

A standard test condition is a test condition of a test standard (STC) for a photovoltaic module accepted in the art, i.e., AM=1.5; 1000 W/m²; 25° C., wherein AM means air-mass, AM=1.5 means that an actual distance of light passing through the atmosphere is 1.5 times the vertical thickness of the atmosphere; 1000 W/m² is an irradiancy of light in a standard test for a solar cell; 25° C. means that the operation is performed at 25° C.

An average operating temperature of the cells of the photovoltaic modules corresponding to the current operating condition is calculated based on irradiancies of the photovoltaic modules at a time corresponding to the current operating condition in a typical year and temperatures of the photovoltaic modules at the time corresponding to the current operating condition in a typical year. The calculation is based on the following formula:

$${T}_{cell\_typ \_avg} = \frac{\sum ( {H}_{typ\_i} * {T}_{cell\_typ \_i} )}{\sum {H}_{typ\_i}}$$

T_{cell_typ_avg} represents the average operating temperature of cells of the photovoltaic module corresponding to the current operating condition, H_{typ_i} represents an irradiancy at a detection time corresponding to the current operating condition in a typical year, and T_{cell_typ_i} represents the temperature of the photovoltaic module at the detection time corresponding to the current operating condition in a typical year.

The theoretical power and theoretical maximum short-circuit current of the photovoltaic string under the current operating condition are calculated based on the irradiancy of the photovoltaic field station under the current operating condition, the average operating temperature of cells of the photovoltaic modules and the temperature of cells of the photovoltaic modules under the current operating condition. The calculation is based on the following formulas:

$${I}_{i\_max} = K * {I}_{s t c} \frac{{H}_{i} [ 1 - \frac{δ}{100} ( {T}_{cell\_typ \_avg} - {T}_{cell} ) ]}{{G}_{stc}} \\ {P}_{i} = {P}_{s t c} * \frac{{H}_{i} * [ 1 - \frac{δ}{100} ( {T}_{cell\_typ \_avg} - {T}_{cell} ) ]}{{G}_{s t c}} * n$$

Pᵢ represents the theoretical power of the photovoltaic string under the current operating condition, I_{i_max} represents the theoretical short-circuit current of the photovoltaic string under the current operating condition, δ represents the power temperature coefficient of the photovoltaic module and its unit is %/° C., n is the number of the photovoltaic modules constitute the photovoltaic string, K is an experience parameters affected by the installation situation of the photovoltaic module, P_{stc} represents the nominal power of the photovoltaic module under the standard operating condition, I_{stc} represents the nominal short-circuit current of the photovoltaic module under the standard operating condition, P_{stc} and I_{stc} may be acquired from a product specification of the photovoltaic module.

It should be noted that, a current flowing through the photovoltaic string is just a current flowing through each photovoltaic module since the photovoltaic string is formed by several photovoltaic modules connected in series, while power generated by the photovoltaic string is equal to the sum of power generated by all photovoltaic modules in the photovoltaic string. In practice, specifications of photovoltaic modules constitute the photovoltaic string are generally of the same, therefore a power of the photovoltaic string may be calculated by multiplying the power of a single photovoltaic module by the number of photovoltaic modules constitute the photovoltaic string.

In step 205, a typical year theoretical power and a typical year maximum short-circuit current of the photovoltaic string are calculated.

In some embodiments, irradiancies of the photovoltaic field station in a typical year are acquired according to a geographic location of the photovoltaic field station, wherein an interval of collecting an irradiancy of the photovoltaic field station in the typical year is identical to an interval of acquiring an irradiancy of the photovoltaic field station under the operating condition.

A maximum irradiancy among irradiancies of the photovoltaic field station in the typical year is selected, and the typical year theoretical power and the typical year maximum short-circuit current of the photovoltaic string in the photovoltaic field station are calculated based on the maximum irradiancy in the typical year.

The typical year theoretical power and the typical year maximum short-circuit current of the photovoltaic string are calculated by using the following formulas:

$${I}_{sc\_tmy \_max} = \frac{{I}_{s t c} * {H}_{tmy\_max}}{{G}_{s t c}}$$

$${P}_{tmy\_max} = \frac{{P}_{s t c} * {H}_{tmy\_max}}{{G}_{s t c}} * n$$

I_{sc_tmy_max} represents the typical year theoretical short-circuit current of the photovoltaic string, P_{tmy_max} represents the typical year theoretical power, I_{stc} represents the nominal short-circuit current of the photovoltaic module under the standard operating condition, and H_{tmy_max} represents the maximum irradiancy of the photovoltaic string in a typical year.

In step 206, standard state parameters of the photovoltaic string are established based on the theoretical power, the theoretical maximum short-circuit current, the typical year theoretical power, and the typical year maximum short-circuit current of the photovoltaic string. The standard state parameters include a power threshold and a short-circuit current threshold of the photovoltaic string.

In some embodiments, a smaller one of the theoretical power and the typical year theoretical power of the photovoltaic string is determined as the power threshold; a smaller one of the theoretical maximum short-circuit current and the typical year maximum short-circuit current of the photovoltaic string is determined as the short-circuit current threshold.

The current threshold and the power threshold are expressed as follows:

Iₜₕᵣₑₛ=min(I_{i_max},I_{sc_tmy_max})

Pₜₕᵣₑₛ=min(Pᵢ,P_{tmy_max})

Iₜₕᵣₑₛ represents the short-circuit current threshold of the photovoltaic string, Pₜₕᵣₑₛ represents the power threshold of the photovoltaic string.

In step 207, operating state parameters of the photovoltaic string under the current operating condition in the detection period are acquired.

In some embodiments, a DC side operating current and operating power of a DC combiner box or a string-type inverter of the photovoltaic string under the current operating condition in the detection period are acquired.

The combiner box is a device for combining and monitoring. In practice, a number of photovoltaic cells with same specification are connected in series to form a plurality of photovoltaic strings to be connected in parallel in a photovoltaic combiner box.

An inverter is a device that converts a DC power to an AC power.

A detection operation on the operating current and operating power of photovoltaic string may be performed on the DC side of the DC combiner box and the string-type inverter to acquire the operating current and the operating power of the entire photovoltaic string. Therefore, it is not necessary to perform detection and calculation on single photovoltaic modules, thereby improving calculation efficiency.

In step 208, the operating state of the photovoltaic string is determined by comparing the operating state parameters of the photovoltaic string with the corresponding standard state parameters of the photovoltaic string.

In some embodiments, it is determined that power of the photovoltaic string is inflated in response to a case where the operating state parameters of the photovoltaic string are greater than the standard state parameters of the photovoltaic string for a duration longer than a first time-threshold.

The determination is based on the following relations:

Iₓ>Iₜₕᵣₑₛ

Pₓ>Pₜₕᵣₑₛ

Iₓ represents the operating current of the photovoltaic string, Pₓ represents the operating power of the photovoltaic string, and the following relation is satisfied:

T_{dur1}>T₁

In this case, a current or power of the photovoltaic string is inflated, and a related warning message is automatically issued by a server for alarm. T_{dur1} represents a duration in which the current or power of the photovoltaic string keeps inflated, T₁ represents the first time-threshold set in advance. That is, a temporary inflation of the current or power of the photovoltaic string may not trigger a warning message, and the message may be issued only after the current or power of the photovoltaic string keeps inflated for a duration, thereby avoiding issuing wrong instructions to an operation and maintenance personnel under a misjudgment of the operating state of the photovoltaic string due to an accident. When it is confirmed that a current or a power of the photovoltaic string is inflated, the server may issue corresponding instructions to remind the operation and maintenance personnel to perform a corresponding inspection. The inspection is generally checking a communication module or line of the photovoltaic string, since the inflation generally occurs when the communication module fails or line data is abnormal.

The first time-threshold may be 1 hour.

It is determined that a short-circuit occurs in the photovoltaic string in response to a case where a current in the operating state parameters of the photovoltaic string is less than a current threshold for a duration greater than a second time-threshold.

The determination is based on the following relation:

Iₓ<I₁

I₁ represents the current threshold, and the value of I₁ may be 0.01 A, and the following relation is satisfied:

T_{dur2}>T₂

In this case, the photovoltaic string is disconnected, and a warning message is issued automatically by the server for alarm.

This case may be caused by fuse blowing, damage of fuse base damage, detachment or blowing of a module connection terminal in the photovoltaic string, burning-out of a module junction box in the photovoltaic string, and the like. The server may give corresponding instructions to an operation and maintenance personnel according to the above-mentioned possible situations.

T_{dur2} represents a duration for which the photovoltaic string is disconnected, T₂ represents the second time-threshold set in advance, the second time-threshold may be 30 minutes.

It is determined that a current or power of the photovoltaic string is low in response to a case where the operating state parameters of the photovoltaic string are less than weighted standard state parameters of the photovoltaic string for a duration greater than a third time-threshold.

The determination is based on the following relations:

Iₓ<α*Iₜₕᵣₑₛ

Pₓ<β*Pₜₕᵣₑₛ

wherein α and β represent experience parameters, and the following relation is satisfied:

T_{dur3}>T₃

In this case, a current or power of the photovoltaic string is low, and the photovoltaic string has low power generation performance, then a corresponding warning message is issued automatically by the server for alarm.

T_{dur3} represents a duration in which the photovoltaic string is disconnected, T₃ represents the third time-threshold set in advance. In other words, a temporary low level of the current or power of the photovoltaic string may not trigger a warning message, and the message may be issued only after the current or power of the photovoltaic string keeps in a low level for a duration, thereby avoiding issuing wrong instructions to an operation and maintenance personnel under a misjudgment of the operating state of the photovoltaic string due to an accident. When it is determined that the photovoltaic string has low performance, the server may issue corresponding instructions to remind the operation and maintenance personnel to check the photovoltaic string. If a photovoltaic string with low performance has no inherent perennial shadow, local dust or other severe contamination, it may be determined that the photovoltaic modules are severely attenuated or damaged. The operation and maintenance personnel should perform relevant performance tests to the photovoltaic string, such as a health detection on the photovoltaic string by using a thermal imager or EL tester, and the photovoltaic string with low performance is replaced so as to reduce a loss of power generation.

The third time-threshold may be 3 hours.

It should be noted that, the first time-threshold, the second time-threshold and the three time-threshold may be adjusted according to actual situation, and the present disclosure does not limit values of the first time-threshold, the second time-threshold and the three time-threshold.

In summary, in the method for recognizing an operating state of a photovoltaic string according to the embodiments of the present disclosure, the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy in determining the operating state of a photovoltaic string.

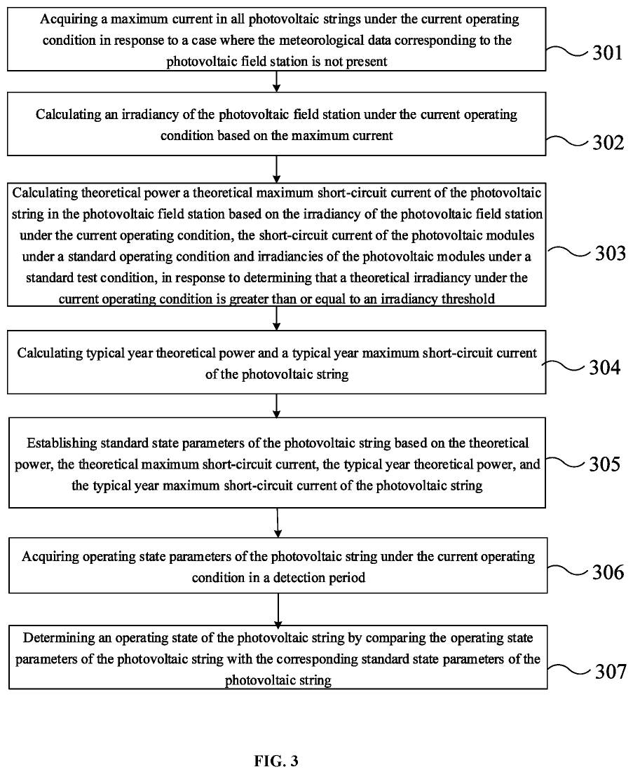

In a case where the photovoltaic field station has no weather station or the meteorological data corresponding to the photovoltaic field station may not be acquired, FIG. 3, which illustrates a flowchart of a method for recognizing an operating state of a photovoltaic string according to an exemplary embodiment of the present disclosure, may be referred to. The method for recognizing an operating state of a photovoltaic string may be performed by a server. As shown in FIG. 3, the method may include the following steps:

In step 301, a maximum current in all of the photovoltaic strings under the current operating condition is acquired in response to a case where the meteorological data corresponding to the photovoltaic field station is not present.

In step 302, an irradiancy of the photovoltaic field station under the current operating condition is calculated based on the maximum current.

Since the meteorological data corresponding to the photovoltaic field station may not be acquired, the irradiancy of the photovoltaic field station may not be acquired. Therefore, the theoretical irradiancy under the current operating condition needs to be converted from existing operating data of the photovoltaic field station for determining whether an irradiancy under the current operating condition meets a condition of being greater than or equal to the irradiancy threshold.

The calculation is based on the following formula:

$${H}_{i\_th} = \frac{{I}_{mp\_all \_max} * {G}_{stc}}{{I}_{sc\_stc}}$$

H_{i_th} represents the theoretical irradiancy under the current operating condition, I_{mp_all_max} represents a maximum current in all of the photovoltaic strings under the current operating condition.

In step 303, the theoretical power and theoretical maximum short-circuit current of the photovoltaic string in the photovoltaic field station are calculated based on an irradiancy of the photovoltaic field station under the current operating condition, the short-circuit current of the photovoltaic modules under a standard operating condition and irradiancies of the photovoltaic modules under a standard test condition, in response to determining that the theoretical irradiancy under the current operating condition is greater than or equal to the irradiancy threshold.

The logic for determining that the theoretical irradiancy under the current operating condition is greater than or equal to the irradiancy threshold is as follows:

H_{i_th}≥Hₜₕᵣₑₛ

The theoretical power and theoretical maximum short-circuit current of the photovoltaic string in the photovoltaic field station based on the irradiancy of the photovoltaic field station under the current operating condition, the short-circuit current of the photovoltaic modules under a standard operating condition and irradiancies of the photovoltaic modules under a standard test condition are calculated by using the following formulas:

$${I}_{i\_max \_th} = K * {I}_{s t c} * \frac{{H}_{i\_th}}{{G}_{s t c}}$$

$${P}_{i\_th} = {P}_{s t c} * \frac{{H}_{i\_th}}{{G}_{s t c}} * n$$

I_{i_max_th} represents the theoretical maximum short-circuit current under the current operating condition, and P_{i_th} represents the theoretical power under the current operating condition.

In step 304, typical year theoretical power and a typical year maximum short-circuit current of the photovoltaic string are calculated.

In step 305, standard state parameters of the photovoltaic string are established based on the theoretical power, the theoretical maximum short-circuit current, the typical year theoretical power, and the typical year maximum short-circuit current of the photovoltaic string. The standard state parameters include a power threshold and a short-circuit current threshold of the photovoltaic string.

In some embodiments, a smaller one of the theoretical power and the typical year theoretical power of the photovoltaic string is determined as the power threshold; and a smaller one of the theoretical maximum short-circuit current and the typical year maximum short-circuit current of the photovoltaic string is determined as the short-circuit current threshold.

The current threshold and the power threshold are expressed as follows:

Iₜₕᵣₑₛ=min(I_{i_max_th},I_{sc_tmy_max})

Pₜₕᵣₑₛ=min(P_{i_th},P_{tmy_max})

In step 306, operating state parameters of the photovoltaic string under the current operating condition in the detection period are acquired.

In step 307, the operating state of the photovoltaic string is determined by comparing the operating state parameters of the photovoltaic string with the corresponding standard state parameters of the photovoltaic string.

Details of steps 304, 306 and 307 are omitted herein, and for the details, reference may be made to the related contents of steps 205, 207 and 208 in the embodiment shown in FIG. 2.

In summary, in the method according to the embodiments of the present disclosure, the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy in determining the operating state of a photovoltaic string.

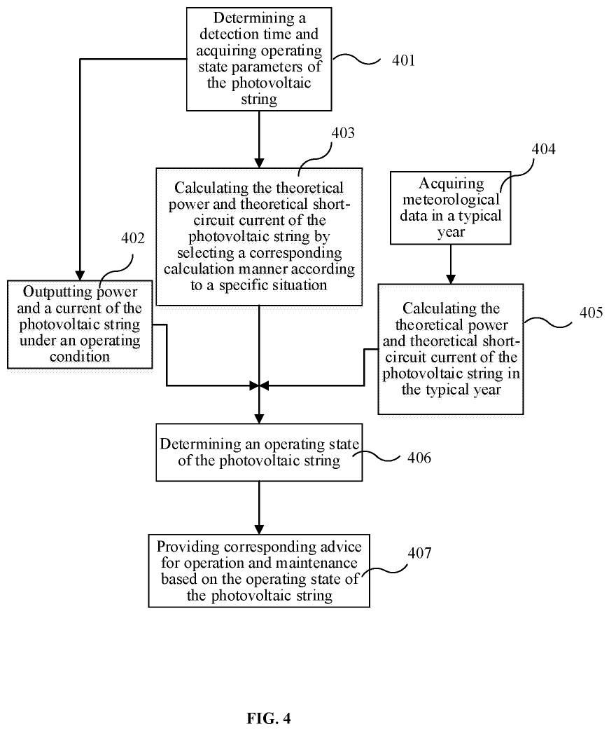

FIG. 4 illustrates a flowchart of a method for recognizing an operating state of a photovoltaic string according to an exemplary embodiment of the present disclosure. The method may be performed by a server. As shown in FIG. 4, the method may include the following steps:

In step 401, a detection time is determined and operating state parameters of the photovoltaic string are acquired.

In step 402, an operating power and an operating current of the photovoltaic string under the operating condition are output.

Operating state parameters of the photovoltaic string acquired in the step 401 include the operating power and operating current of the photovoltaic string under the operating condition, which indicate a part of the operating state parameters of the photovoltaic string during the detection time.

In step 403, a theoretical power and a theoretical short-circuit current of the photovoltaic string are calculated by selecting a corresponding calculation manner according to a specific situation.

In step 404, meteorological data in a typical year is acquired.

The meteorological data in the typical year of the photovoltaic field station where the photovoltaic string is located is acquired.

In step 405, a theoretical power and a theoretical short-circuit current of the photovoltaic string in the typical year are calculated.

The theoretical power and theoretical short-circuit current of the photovoltaic string in the typical year are calculated based on the meteorological data in the typical year.

In step 406, the operating state of the photovoltaic string is determined.

The operating state of the photovoltaic string is determined based on the theoretical power and the theoretical short-circuit current of the photovoltaic string, the operating power and the operating current of the photovoltaic string under the operating condition as well as the theoretical power and the theoretical short-circuit current of the photovoltaic string in the typical year.

In step 407, corresponding advice for operation and maintenance is provided based on the operating state of the photovoltaic string.

In summary, in the method according to the embodiments of the present disclosure, the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy in determining the operating state of a photovoltaic string.

An exemplary embodiment of the present disclosure provides a method for recognizing an operating state of a photovoltaic string, which may be performed by a server, and the server may be implemented as a cloud monitoring platform. The method may include the following steps:

I. In Photovoltaic Field Stations with Weather Stations:

In step 1, an irradiancy of the photovoltaic field station is acquired, and state data of the photovoltaic string in a period with an irradiancy greater than 300 w/m² is selected as the operating state data.

In step 2, theoretical power Pᵢ and a theoretical short-circuit current I_{i_max} of the photovoltaic string under the current operating condition are calculated.

In step 3, a maximum irradiancy H_{tmy_max} in irradiancies of typical year of the photovoltaic field station is acquired.

In step 4, typical year theoretical power P_{tmy_max} and a typical year maximum short-circuit current I_{sc_tmy_max} of the photovoltaic string are calculated based on the maximum irradiancy H_{tmy_max}.

In step 5, a smaller one of the theoretical power Pᵢ and the typical year theoretical power P_{tmy_max} is determined as the power threshold Pₜₕᵣₑₛ in the standard state parameters, and a smaller one of the theoretical short-circuit current I_{i_max} and the typical year maximum short-circuit current I_{sc_tmy_max} is determined as the short-circuit current threshold Iₜₕᵣₑₛ in the standard state parameters.

In step 6, an operating power Pₓ and an operating current Iₓ of the photovoltaic string under the current operating condition are acquired.

In step 7, a first time-threshold T₁ is set. If the operating power Pₓ and an operating current Iₓ of the photovoltaic string satisfy the following relation:

Iₓ>Iₜₕᵣₑₛ

Pₓ>Pₜₕᵣₑₛ

and the duration T_{dur} satisfies the following relation:

T_{dur}>T₁

then a cloud system determines that the current or power of the photovoltaic string is inflated, and automatically sends a warning message.

In step 8, the current threshold I₁ and the second time-threshold T₂ are set, if the operating current Iₓ satisfies the following relations:

Iₓ<Iₜₕᵣₑₛ

T_{dur}>T₂

then the cloud system determines that the photovoltaic string is disconnected and automatically sends warning information.

In step 9, a third time-threshold T₃ is set. If the operating power Pₓ and the operating current Iₓ of the photovoltaic string satisfy the following relations:

Iₓ<α*Iₜₕᵣₑₛ

Pₓ<β*Pₜₕᵣₑₛ

and the duration T_{dur} satisfies the following relation:

T_{dur}>T₃

wherein α and β are experience coefficients;

then the cloud system determines that the photovoltaic string has low performance, and automatically sends a warning message.

II. In Photovoltaic Field Stations without Weather Stations:

In step 1, a maximum current I_{mp_all_max} among currents of all photovoltaic string in the photovoltaic field station under the current operating condition is acquired.

In step 2, an irradiancy H_{i_th} of the photovoltaic field station is calculated, and state data of the photovoltaic string in a period with an irradiancy greater than 300 w/m² is selected as the operating state data.

In step 3, a theoretical power P_{i_th} and a theoretical short-circuit current I_{i_max_th} of the photovoltaic string under the current operating condition are calculated based on an irradiancy H_{i_th} of the photovoltaic field station.

In step 3, a maximum irradiancy H_{tmy_max} in irradiancies in the typical year of the photovoltaic field station is acquired.

In step 4, typical year theoretical power P_{tmy_max} and a typical year maximum short-circuit current I_{sc_tmy_max} of the photovoltaic string are calculated based on the maximum irradiancy H_{tmy_max}.

In step 5, a smaller one of the theoretical power P_{i_th} and the typical year theoretical power P_{tmy_max} is determined as the power threshold Pₜₕᵣₑₛ in the standard state parameters, and a smaller one of the theoretical short-circuit current I_{i_max_th} and the typical year maximum short-circuit current I_{sc_tmy_max} is determined as the short-circuit current threshold Iₜₕᵣₑₛ in the standard state parameters.

In step 6, an operating power Pₓ and an operating current Iₓ of the photovoltaic string under the current operating condition are acquired.

In step 7, a first time-threshold T₁ is set. If the operating power Pₓ and the operating current Iₓ of the photovoltaic string satisfy the follows:

Iₓ>Iₜₕᵣₑₛ

Pₓ>Pₜₕᵣₑₛ

and the duration T_{dur} satisfies the follows:

T_{dur}>T₁

then the cloud system determines that a current or power of the photovoltaic string is inflated, and automatically sends a warning message.

In step 8, the current threshold I₁ and the second time-threshold T₂ are set. If the operating current Iₓ satisfies the follows:

Iₓ<Iₜₕᵣₑₛ

T_{dur}>T₂

then the cloud system determines that the photovoltaic string is disconnected and automatically sends warning information.

In step 9, a third time-threshold T₃ is set. If the operating power Pₓ and the operating current Iₓ of the photovoltaic string satisfy the follows:

Iₓ<α*Iₜₕᵣₑₛ

Pₓ<β*Pₜₕᵣₑₛ

and the duration T_{dur} satisfies the follows:

T_{dur}>T₃

wherein α and β are experience coefficients;

then the cloud system determines that the photovoltaic string has low performance, and automatically sends a warning message.

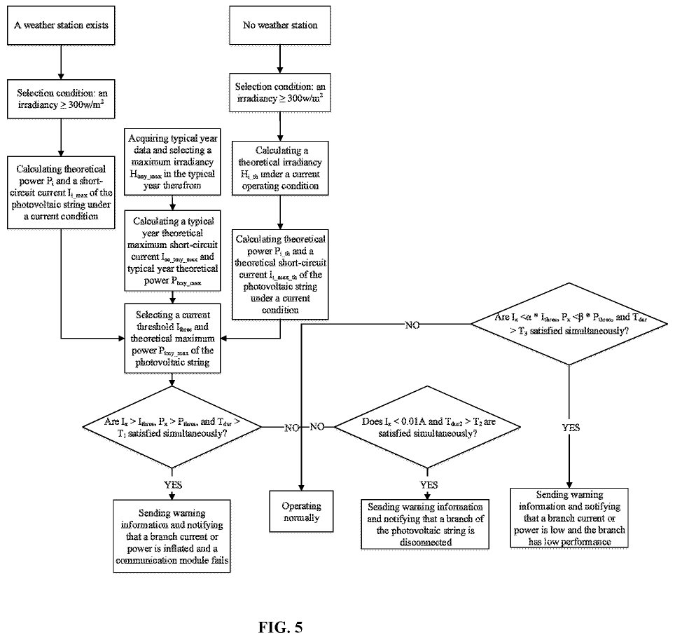

FIG. 5 illustrates a flowchart of a method for recognizing an operating state of a photovoltaic string according to an exemplary embodiment of the present disclosure. For the logic of performing the above steps, reference may be made to FIG. 5. As shown in FIG. 5, in recognition of the photovoltaic string operating state, the theoretical irradiancy under the current operating condition and the theoretical power and theoretical current of the photovoltaic string are acquired with different manners for a scene of having a weather station and a scene of having no weather station, then the standard state parameters are determined based on the calculated typical year theoretical maximum short-circuit current and the typical year theoretical power, the operating state parameters are compared with the standard state parameters to determine an operating state of the photovoltaic string, and corresponding advice is given based on the determined operating state of the photovoltaic string.

In summary, in the method according to the embodiments of the present disclosure, the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy in determining the operating state of a photovoltaic string.

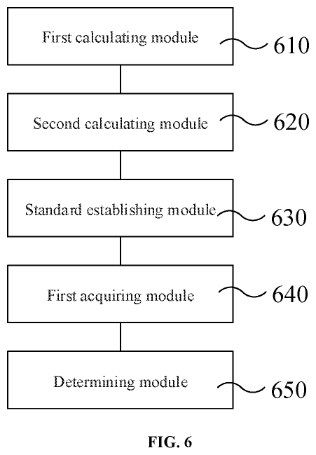

FIG. 6 illustrates a block diagram of an apparatus for recognizing an operating state of a photovoltaic string according to an exemplary embodiment of the present disclosure. The apparatus may be implemented as all or part of a server in the form of software to perform all or part of the steps of the method according to the corresponding embodiment shown in FIG. 1, FIG. 2, FIG. 3, FIG. 4, or FIG. 5. As shown in FIG. 6, the apparatus may include a first calculating module 610, a second calculating module 620, a standard establishing module 630, a first acquiring module 640, and a determining module 650.

The first calculating module 610 is configured to calculate a theoretical power and a theoretical maximum short-circuit current of a photovoltaic string under the current operating condition, wherein the photovoltaic string is a circuit unit with a DC output formed by at least two photovoltaic modules connected in series.

The second calculating module 620 is configured to calculate a typical year theoretical power and a typical year maximum short-circuit current of the photovoltaic string.

The standard establishing module 630 is configured to establish standard state parameters of the photovoltaic string based on the theoretical power, the theoretical maximum short-circuit current, the typical year theoretical power, and the typical year maximum short-circuit current of the photovoltaic string, wherein the standard state parameters include a power threshold and a short-circuit current threshold of the photovoltaic string.

The first acquiring module 640 is configured to acquire operating state parameters of the photovoltaic string under the current operating condition, wherein the operating state parameters include an operating power and an operating current of the photovoltaic string.

The determining module 650 is configured to determine the operating state of the photovoltaic string by comparing the operating state parameters of the photovoltaic string with the corresponding standard state parameters of the photovoltaic string.

In some embodiments, the standard establishing module 630 includes: a first acquiring submodule, configured to determine a smaller one of the theoretical power and the typical year theoretical power of the photovoltaic string as the power threshold; and a second acquiring submodule, configured to determine a smaller one of the theoretical maximum short-circuit current and the typical year maximum short-circuit current of the photovoltaic string as the short-circuit current threshold.

In some embodiments, the apparatus further includes: a second acquiring module, configured to acquire, at a preset interval, an instantaneous irradiancy of the photovoltaic field station where the photovoltaic string is installed; a third acquiring module, configured to determine a period during which the instantaneous irradiancy of the photovoltaic field station is greater than or equal to an irradiancy threshold as a detection period; and a fourth acquiring module, configured to determine an operating condition in a specified period within the detection period as the current operating condition.

In some embodiments, the first acquiring module 640 is configured to acquire a DC side operating current and an operating power of a DC combiner box or a string-type inverter of the photovoltaic string under the current operating condition in the detection period.

In some embodiments, the first calculating module 610 includes: a third acquiring submodule, configured to acquire an irradiancy, an ambient temperature, and a wind speed of the photovoltaic field station under the current operating condition based on the meteorological data corresponding to the photovoltaic field station in response to presence of the meteorological data; a first calculating submodule, configured to calculate temperatures of the photovoltaic modules in the photovoltaic string under the current operating condition based on the irradiancy, the ambient temperature, and the wind speed of the photovoltaic field station under the current operating condition; a second calculating submodule, configured to calculate temperatures of cells of the photovoltaic modules under the current operating condition based on the temperatures of the photovoltaic modules; a third calculating submodule, configured to calculate an average operating temperature of the cells of the photovoltaic modules corresponding to the current operating condition based on irradiancies of the photovoltaic modules at the detection time corresponding to the current operating condition in a typical year and the temperatures of the photovoltaic modules at the detection time corresponding to the current operating condition in a typical year; and a fourth calculating submodule, configured to calculate theoretical power and a theoretical maximum short-circuit current of the photovoltaic string under the current operating condition based on the irradiancy of the photovoltaic field station under the current operating condition, the average operating temperature of the cells of the photovoltaic modules and the temperatures of cells of the photovoltaic modules under the current operating condition.

In some embodiments, the first calculating module 610 includes: a fourth acquiring submodule, configured to acquire a maximum current in all of the photovoltaic strings under the current operating condition in response to a case where the meteorological data corresponding to the photovoltaic field station is not present; a fifth calculating submodule, configured to calculate an irradiancy of the photovoltaic field station under the current operating condition based on the maximum current, and a sixth calculating submodule, configured to calculate theoretical power and a theoretical maximum short-circuit current of the photovoltaic string in the photovoltaic field station based on the irradiancy of the photovoltaic field station under the current operating condition, the short-circuit current of the photovoltaic modules under a standard operating condition and irradiancies of the photovoltaic modules under a standard test condition.

In some embodiments, the second calculating module 620 includes: a fifth acquiring submodule, configured to acquire irradiancies of the photovoltaic field station in a typical year according to a geographic location of the photovoltaic field station, wherein an interval of collecting an irradiancy of the photovoltaic field station in the typical year is identical to an interval of acquiring an irradiancy of the photovoltaic field station under the operating condition; a selecting submodule, configured to select a maximum irradiancy among the irradiancies of the photovoltaic field station in the typical year at the detection time corresponding to the current operating condition; and a seventh calculating submodule, configured to calculate typical year theoretical power and a typical year maximum short-circuit current of the photovoltaic string in the photovoltaic field station based on the maximum irradiancy.

In some embodiments, the determining module 650 includes: a first determining submodule, configured to determine that power of the photovoltaic string is inflated in response to a case where the operating state parameters of the photovoltaic string are greater than the standard state parameters of the photovoltaic string for a duration longer than a first time-threshold; a second determining submodule, configured to determine that a short-circuit occurs in the photovoltaic string in response to a case where a current in the operating state parameters of the photovoltaic string is less than a current threshold for a duration greater than a second time-threshold; and a third determining submodule, configured to determine that a current or power of the photovoltaic string is low in response to a case where the operating state parameters of the photovoltaic string are less than the weighted standard state parameters of the photovoltaic string for a duration greater than a third time-threshold.

In summary, the apparatus according to the embodiments of the present disclosure is applied in a server, wherein the theoretical power and the theoretical maximum short-circuit current of a photovoltaic string under the current operating condition as well as the typical year theoretical power and the typical year maximum short-circuit current of the photovoltaic string are calculated to establish standard state parameters including a power threshold and a short-circuit current threshold of the photovoltaic string, operating state parameters of the photovoltaic string are acquired, and an operating state of the photovoltaic string is determined by comparing the operating state parameters with the corresponding standard state parameters of the photovoltaic string. Therefore, an actual operating state of the photovoltaic string can be acquired by a benchmark determination on the operating parameters of the photovoltaic string during operation and maintenance of a photovoltaic power plant, thereby improving the accuracy of determination of the operating state of a photovoltaic string.

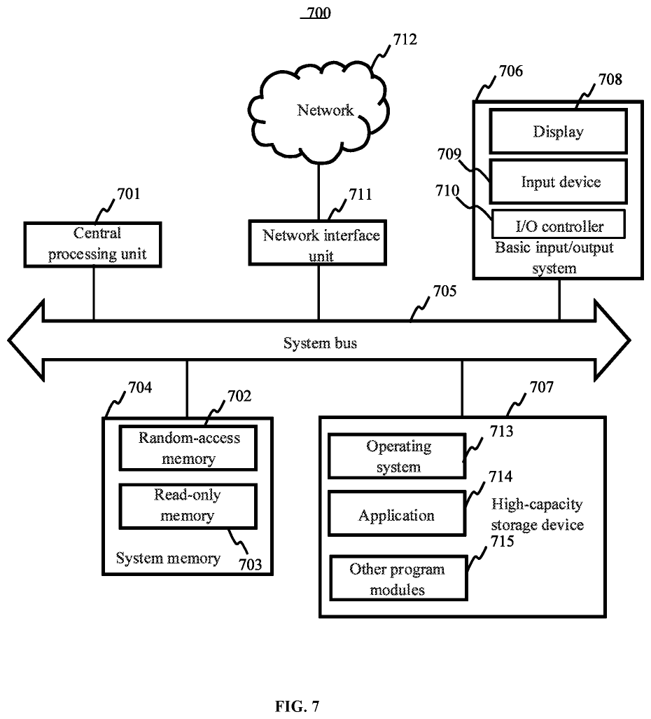

FIG. 7 illustrates a schematic structural diagram of a computer device according to an exemplary embodiment of the present disclosure. The computer device may be implemented as the above-mentioned server in the solutions of the present disclosure. The computer device 700 includes a central processing unit (CPU) 701, a system memory 704 including a random-access memory (RAM) 702 and a read-only memory (ROM) 703, and a system bus 705 connecting the system memory 704 and the CPU 701. The computer device 700 further includes a basic input/output system (I/O system) 706 which helps transmit information between various components within a computer, and a high-capacity storage device 707 for storing an operating system 713, an application 714, and other program modules 715.

The basic I/O system 706 includes a display 708 for displaying information and an input device 709, such as a mouse and a keyboard, for a user to input the information. The display 708 and the input device 709 are both connected to the CPU 701 by an I/O controller 710 connected to the system bus 705. The basic I/O system 706 may also include the I/O controller 710 for receiving and processing input from a plurality of other devices, such as a keyboard, a mouse and an electronic stylus. Similarly, the I/O controller 710 further provides output to a display screen, a printer or other types of output devices.

The high-capacity storage device 707 is connected to the CPU 701 by a high-capacity storage controller (not shown) connected to the system bus 705. The high-capacity storage device 707 and its associated computer-readable medium provide non-volatile storage for the computer device 700. That is, the high-capacity storage device 707 may include a computer-readable medium (not shown), such as a hard disk or a CD-ROM drive.

Without loss of generality, the computer-readable medium may include a computer storage medium and a communication medium. The computer storage medium includes volatile and non-volatile, removable and non-removable media implemented in any method or technology for storage of information such as a computer-readable instruction, a data structure, a program module or other data. The computer storage medium includes a RAM, a ROM, an EPROM, an EEPROM, a flash memory or other solid-state storage devices; a CD-ROM, DVD or other optical storage devices; and a tape cartridge, a magnetic tape, a disk storage or other magnetic storage devices. It will be known by a person skilled in the art that the computer storage medium is not limited to above. The above system memory 704 and the high-capacity storage device 707 may be collectively referred to as the memory.

According to various embodiments of the present disclosure, the computer device may also be connected to a remote computer on a network over the network, such as the Internet, for operation. That is, the computer device 700 may be connected to the network 712 by a network interface unit 711 connected to the system bus 705, or may be connected to other types of networks or remote computer systems (not shown) with the network interface unit 711.

The memory further includes one or more programs stored in the memory. The one or more programs, when loaded and rub by the CPU 701, cause the CPU 701 to perform all or part of the steps of the method shown in FIG. 1, FIG. 2, FIG. 3, FIG. 4 or FIG. 5.

Those skilled in the art will appreciate that in one or more examples described above, the functions described in the embodiments of the present disclosure can be implemented in hardware, software, firmware, or any combination thereof. When implemented in software, the functions may be stored in a computer-readable medium or transmitted as one or more instructions or codes on the computer-readable medium. The computer-readable medium includes both a computer storage medium and a communication medium including any medium that facilitates transfer of a computer program from one location to another. The storage medium may be any available medium that can be accessed by a general-purpose or special-purpose computer.

An exemplary embodiment provides a non-transitory computer-readable storage medium storing at least one instruction, at least one program, a code set, or an instruction set. The at least one instruction, the at least one program, the code set, or the instruction set, when loaded and executed by a processor of a computer device, causes the computer device to perform all or part of the steps of the method according to any of the above-described embodiments shown in FIG. 2, FIG. 3 and FIG. 4. For example, the non-transitory computer-readable storage medium may be a ROM, a RAM, a CD-ROM, a magnetic tape, a floppy disk, an optical data storage device, or the like.

Other embodiments of the present disclosure will be apparent to those skilled in the art from consideration of the specification and practice of the present disclosure. This application is intended to cover any variations, uses, or adaptations of the present disclosure following the general principles thereof and including common knowledge or commonly used technical measures which are not disclosed herein. The specification and embodiments are to be considered as exemplary only, with a true scope and spirit of the present disclosure is indicated by the following claims.

The present disclosure is not limited to the exact constructions that have been described above and illustrated in the accompanying drawings, and various modifications and changes can be made without departing from the scope thereof. It is intended that the scope of the present disclosure is only subject to the appended claims.

1. (canceled)

2. The method according to claim 3, wherein establishing the standard state parameters of the photovoltaic string based on the theoretical power, the theoretical maximum short-circuit current, the typical year theoretical power, and the typical year maximum short-circuit current of the photovoltaic string comprises:
determining a smaller one of the theoretical power and the typical year theoretical power of the photovoltaic string as the power threshold; and
determining a smaller one of the theoretical maximum short-circuit current and the typical year maximum short-circuit current of the photovoltaic string as the short-circuit current threshold.

3. A method for recognizing an operating state of a photovoltaic string, comprising:
acquiring, at a preset interval, an instantaneous irradiancy of a photovoltaic field station where the photovoltaic string is installed;
determining a period during which the instantaneous irradiancy of the photovoltaic field station is greater than or equal to an irradiancy threshold as a detection period; and
determining an operating condition in a specified period within the detection period as a current operating condition;
calculating a theoretical power and a theoretical maximum short-circuit current of the photovoltaic string under the current operating condition, wherein the photovoltaic string is a circuit unit with a DC output formed by at least two photovoltaic modules connected in series;
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining an operating state of the photovoltaic string by comparing the operating state parameters of the photovoltaic string with the corresponding standard state parameters of the photovoltaic string.

4. A method for recognizing an operating state of a photovoltaic string, comprising:
calculating a theoretical power and a theoretical maximum short-circuit current of the photovoltaic string under a current operating condition, wherein the photovoltaic string is a circuit unit with a DC output formed by at least two photovoltaic modules connected in series; and
wherein calculating the theoretical power and the theoretical maximum short-circuit current of the photovoltaic string under the current operating condition comprises:
acquiring an irradiancy, an ambient temperature, and a wind speed of a photovoltaic field station under the current operating condition based on meteorological data corresponding to the photovoltaic field station in response to presence of the meteorological data;
calculating temperatures of the at least two photovoltaic modules in the photovoltaic string under the current operating condition based on the irradiancy, the ambient temperature, and the wind speed of the photovoltaic field station under the current operating condition;
calculating temperatures of cells of the photovoltaic modules under the current operating condition based on the temperatures of the photovoltaic modules;
calculating an average operating temperature of the cells of the photovoltaic modules corresponding to the current operating condition based on irradiancies of the photovoltaic modules at a detection time corresponding to the current operating condition in a typical year and the temperatures of the photovoltaic modules at the detection time corresponding to the current operating condition in a typical year; and
calculating the theoretical power and theoretical maximum short-circuit current of the photovoltaic string under the current operating condition based on the irradiancy of the photovoltaic field station under the current operating condition, the average operating temperature of the cells of the photovoltaic modules and the temperatures of the cells of the photovoltaic modules under the current operating condition;
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining the operating state of the photovoltaic string by comparing the operating state parameters of the photovoltaic string with the corresponding standard state parameters of the photovoltaic string.

5. A method for recognizing an operating state of a photovoltaic string, comprising:
calculating a theoretical power and a theoretical maximum short-circuit current of the photovoltaic string under a current operating condition, wherein the photovoltaic string is a circuit unit with a DC output formed by at least two photovoltaic modules connected in series; and
wherein calculating the theoretical power and the theoretical maximum short-circuit current of the photovoltaic string under the current operating condition comprises:
acquiring a maximum current in all photovoltaic strings under the current operating condition in response to a case where meteorological data corresponding to a photovoltaic field station is not present;
calculating an irradiancy of the photovoltaic field station under the current operating condition based on the maximum current; and
calculating the theoretical power and theoretical maximum short-circuit current of the photovoltaic string in the photovoltaic field station based on the irradiancy of the photovoltaic field station under the current operating condition, the short-circuit current of the at least two photovoltaic modules under a standard operating condition and irradiancies of the at least two photovoltaic modules under a standard test condition;
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining the operating state of the photovoltaic string by comparing the operating state parameters of the photovoltaic string with the corresponding standard state parameters of the photovoltaic string.

6. A method for recognizing an operating state of a photovoltaic string, comprising:
calculating a theoretical power and a theoretical maximum short-circuit current of the photovoltaic string under a current operating condition, wherein the photovoltaic string is a circuit unit with a DC output formed by at least two photovoltaic modules connected in series; and
wherein calculating a typical year theoretical power and a typical year maximum short-circuit current of the photovoltaic string comprises:
acquiring irradiancies of a photovoltaic field station in a typical year according to a geographic location of the photovoltaic field station, wherein an interval of collecting an irradiancy of the photovoltaic field station in the typical year is identical to an interval of acquiring an irradiancy of the photovoltaic field station under the current operating condition;
selecting a maximum irradiancy among the irradiancies of the photovoltaic field station in the typical year at a detection time corresponding to the current operating condition; and
calculating the typical year theoretical power and the typical year maximum short-circuit current of the photovoltaic string in the photovoltaic field station based on the maximum irradiancy;
calculating the typical year theoretical power and the typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining the operating state of the photovoltaic string by comparing the operating state parameters of the photovoltaic string with the corresponding standard state parameters of the photovoltaic string.

7. A method for recognizing an operating state of a photovoltaic string, comprising:
calculating a theoretical power and a theoretical maximum short-circuit current of the photovoltaic string under a current operating condition, wherein the photovoltaic string is a circuit unit with a DC output formed by at least two photovoltaic modules connected in series; and
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining the operating state of the photovoltaic string by comparing the operating state parameters of the photovoltaic string with the corresponding standard state parameters of the photovoltaic string, wherein determining the operating state of the photovoltaic string by comparing the operating state parameters of the photovoltaic string with the corresponding standard state parameters of the photovoltaic string comprises:
determining that a power of the photovoltaic string is inflated in response to a case where the operating state parameters of the photovoltaic string are greater than the standard state parameters of the photovoltaic string for a duration longer than a first time-threshold;
determining that a short-circuit occurs in the photovoltaic string in response to a case where a current in the operating state parameters of the photovoltaic string is less than a current threshold for a duration greater than a second time-threshold; and
determining that current or power of the photovoltaic string is low in response to a case where the operating state parameters of the photovoltaic string are less than weighted standard state parameters of the photovoltaic string for a duration greater than a third time-threshold.

8. (canceled)

9. A computer device, comprising:
a processor; and
a memory storing at least one instruction, at least one program, a code set, or an instruction set; wherein the at least one instruction, the at least one program, the code set, or the instruction set, when loaded and executed by the processor, causes the processor to perform a method comprising:
acquiring, at a preset interval, an instantaneous irradiancy of a photovoltaic field station where the photovoltaic string is installed;
determining a period during which the instantaneous irradiancy of the photovoltaic field station is greater than or equal to an irradiancy threshold as a detection period; and
determining an operating condition in a specified period within the detection period as a current operating condition;
calculating a theoretical power and a theoretical maximum short-circuit current of the photovoltaic string under the current operating condition, wherein the photovoltaic string is a circuit unit with a DC output formed by at least two photovoltaic modules connected in series;
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining an operating state of the photovoltaic string by comparing the operating state parameters of the photovoltaic string with the corresponding standard state parameters of the photovoltaic string.

10. A non-transitory computer-readable storage medium storing at least one instruction, at least one program, a code set, or an instruction set; wherein the at least one instruction, the at least one program, the code set, or the instruction set, when loaded and executed by a processor of a computer device, causes the computer device to perform a method comprising:
acquiring, at a preset interval, an instantaneous irradiancy of a photovoltaic field station where the photovoltaic string is installed;
determining a period during which the instantaneous irradiancy of the photovoltaic field station is greater than or equal to an irradiancy threshold as a detection period; and
determining an operating condition in a specified period within the detection period as a current operating condition;
calculating a theoretical power and a theoretical maximum short-circuit current of the photovoltaic string under the current operating condition, wherein the photovoltaic string is a circuit unit with a DC output formed by at least two photovoltaic modules connected in series;
calculating a typical year theoretical power and a typical year maximum short-circuit current of the photovoltaic string;
establishing standard state parameters of the photovoltaic string based on the theoretical power, the theoretical maximum short-circuit current, the typical year theoretical power, and the typical year maximum short-circuit current of the photovoltaic string, wherein the standard state parameters comprise a power threshold and a short-circuit current threshold of the photovoltaic string;
acquiring operating state parameters of the photovoltaic string under the current operating condition, wherein the operating state parameters comprise an operating power and an operating current of the photovoltaic string; and
determining an operating state of the photovoltaic string by comparing the operating state parameters of the photovoltaic string with the corresponding standard state parameters of the photovoltaic string.

11. The method according to claim 4, wherein establishing the standard state parameters of the photovoltaic string based on the theoretical power, the theoretical maximum short-circuit current, the typical year theoretical power, and the typical year maximum short-circuit current of the photovoltaic string comprises:
determining a smaller one of the theoretical power and the typical year theoretical power of the photovoltaic string as the power threshold; and
determining a smaller one of the theoretical maximum short-circuit current and the typical year maximum short-circuit current of the photovoltaic string as the short-circuit current threshold.

12. The method according to claim 5, wherein establishing the standard state parameters of the photovoltaic string based on the theoretical power, the theoretical maximum short-circuit current, the typical year theoretical power, and the typical year maximum short-circuit current of the photovoltaic string comprises:
determining a smaller one of the theoretical power and the typical year theoretical power of the photovoltaic string as the power threshold; and
determining a smaller one of the theoretical maximum short-circuit current and the typical year maximum short-circuit current of the photovoltaic string as the short-circuit current threshold.

13. The method according to claim 6, wherein establishing the standard state parameters of the photovoltaic string based on the theoretical power, the theoretical maximum short-circuit current, the typical year theoretical power, and the typical year maximum short-circuit current of the photovoltaic string comprises:
determining a smaller one of the theoretical power and the typical year theoretical power of the photovoltaic string as the power threshold; and
determining a smaller one of the theoretical maximum short-circuit current and the typical year maximum short-circuit current of the photovoltaic string as the short-circuit current threshold.

14. The method according to claim 7, wherein establishing the standard state parameters of the photovoltaic string based on the theoretical power, the theoretical maximum short-circuit current, the typical year theoretical power, and the typical year maximum short-circuit current of the photovoltaic string comprises:
determining a smaller one of the theoretical power and the typical year theoretical power of the photovoltaic string as the power threshold; and
determining a smaller one of the theoretical maximum short-circuit current and the typical year maximum short-circuit current of the photovoltaic string as the short-circuit current threshold.
